(19) United States
(12) Patent Application Publication
(10) Pub. No.: US 2026/0233272 A1
(43) Pub. Date: Aug. 13, 2026

(54) REMEDIATION SYSTEMS AND THERMAL MANAGEMENT SYSTEMS

(71) Applicant: ASRC ENERGY SERVICES, LLC, Anchorage, AK (US)

(72) Inventors: Liam Thomas Fairburn ZSOLT, Anchorage, AK (US); Laurence FULLMER, Anchorage, AK (US); Simon Mattias FLANDER, Pearland, TX (US); Lindsay NORRIS, Anchorage, AK (US); Rysen SHIRZADI, Anchorage, AK (US)

(21) Appl. No.: 19/136,617

(22) PCT Filed: Dec. 8, 2023
(86) PCT No.: PCT/US23/83255

§ 371 Date: Jun. 6, 2025

Related U.S. Application Data
(60) Provisional application No. 63/431,228, filed on Dec. 8, 2022.

(51) Int. Cl. B09C 1/06; F23G 7/06; F27B 7/08; F27B 7/32; F27B 7/42; F27D 3/08; F27D 11/06; F27D 17/20; H05B 6/04; H05B 6/44

(52) U.S. Cl. CPC B09C 1/06; F23G 7/061; F27B 7/08; F27B 7/3205; F27B 7/42; F27D 3/08; F27D 11/06; F27D 17/20; H05B 6/44; F23G 2209/14; F27B 2007/3211; F27B 2007/3258; H05B 6/04

(57) ABSTRACT

This disclosure relates to industrial processes. Remediation systems for the removal of PFAS compounds from contaminated soil are disclosed herein. Thermal management systems are disclosed herein for preventing failure of heated, rotatable barrels. Per-and polyfluoroalkyl substance (PFAS) compounds are a large group of compounds (>6,000) that have an alkyl chain. The processes and systems disclosed herein for remediation of PFAS compounds can address the unique characteristics of PFAS compounds.

WO

### CROSS-REFERENCE TO RELATED APPLICATIONS

This application claims priority to U.S. Provisional Patent Application Ser. No. 63/431,228 filed Dec. 8, 2022, and entitled REMEDIATION SYSTEMS AND THERMAL MANAGEMENT SYSTEMS, the entire contents of which are incorporated by reference herein.

### COPYRIGHT NOTICE

@ 2023 ASRC Energy Services. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### Technical Field

This disclosure relates generally to industrial processes and in particular to remediation systems and thermal management systems for processes involving indirectly heated rotary barrels.

### BACKGROUND

Per-and polyfluoroalkyl substance (PFAS) compounds are a large group of compounds (>6,000) that have an alkyl chain. The perfluoroalkyl compounds have fluorine (F) atoms bonded to all of the carbon (C) atoms in the alkyl chain (also referred to as the backbone). The polyfluoroalkyl compounds have some hydrogen (H) atoms in addition to F atoms bonded to the C atoms of the alkyl chain. PFAS compounds 1 have unique surfactant properties. The alkyl tails make these substances both hydrophobic (water-repelling) and oleophobic/lipophobic (oil/fat-repelling).

Because of these properties, PFAS compounds have been used extensively in surface coating and protectant formulations. Major applications have included protectants that enhance water, grease, and soil repellency for paper and cardboard packaging products, carpets, leather products, and textiles. The compounds also have been widely used in industrial surfactants, emulsifiers, wetting agents, additives, and coatings. PFAS compounds have been used in fire-fighting foams because they are effective in extinguishing hydrocarbon-fueled fires. They are also used as processing aids in the manufacture of fluoropolymers, such as nonstick coatings on cookware, membranes for clothing that are both waterproof and breathable, electrical wire casing, fire-and chemical-resistant tubing, and plumbing thread seal tape.

The fluorine-carbon bonds in PFAS compounds are very stable and give these substances high thermal and chemical stability. PFAS compounds are persistent in the environment. Many PFAS compounds are found worldwide in the environment, wildlife, and humans. Bioaccumulation of PFAS compounds in humans is a concern.

Remediation processes and systems for removing PFAS compounds from contaminated materials are disclosed in PCT Publication No. WO2021168462. Additional processes and systems are disclosed herein.

### BRIEF DESCRIPTION OF THE DRAWINGS

The embodiments disclosed herein will become more fully apparent from the following description and appended claims, taken in conjunction with the accompanying drawings. The drawings depict primarily generalized embodiments, which embodiments will be described with additional specificity and detail in connection with the drawings in which:

FIG. 1 illustrates an isometric view of an exemplary embodiment of a system for removing a PFAS compound from contaminated material.

FIG. 2 illustrates a cross-sectional side view of the embodiment illustrated in FIG. 1.

FIG. 3 illustrates a sideview of the embodiment illustrated in FIG. 1 with the housing and several components removed.

FIG. 4 is a block diagram illustrating example physical components of a computing device that may be included or otherwise associated with the systems described herein.

FIG. 5 illustrates an exemplary material-stress curve determined using finite element analysis for an exemplary barrel of the embodiment illustrated in FIG. 1.

### DETAILED DESCRIPTION

Disclosed herein are processes and systems for remediation of per- and polyfluoroalkyl substance (PFAS)-contaminated material.

The binding of PFAS compounds to different materials is governed to a large extent by the surface-active behavior of the PFAS compounds. The fluorinated backbone is both hydrophobic (water repelling) and oleophobic/lipophobic (oil/fat repelling) while the terminal functional group is hydrophilic (water loving). This means that PFAS compounds tend to partition to interfaces, such as between air and water with the fluorinated backbone residing in air and the terminal functional group residing in water. The PFAS partitioning behavior also is affected by the alkyl chain length and the charge on the terminal functional group. In general, PFAS compounds with a shorter alkyl chain length are more water soluble than those with longer lengths. Adsorption to soil surfaces tends to be greater for PFAS compounds with longer alkyl chain length.

At environmentally relevant pH, many PFAS compounds have a negatively charged terminal functional group (i.e., anionic), meaning that they will be repelled from soil that tends to have negatively charged surfaces. Some PFAS compounds have a positively charged terminal functional group (i.e., cation), which strongly bind with soils. And a few PFAS compounds have both positively and negatively charged groups (i.e., zwitterions), which will exhibit partitioning behavior between anionic and cationic compounds.

The processes and systems disclosed herein for remediation of PFAS compounds can address the unique characteristics of PFAS compounds.

The phrase “operably connected to” refers to any form of interaction between two or more entities, including mechanical, electrical, magnetic, electromagnetic, fluid, and thermal interaction. Two entities may interact with each other even though they are not in direct contact with each other. For example, two entities may interact with each other through an intermediate entity.

Systems are disclosed herein for removing per-and polyfluoroalkyl substance (PFAS) compounds. For example, the systems may include a vessel configured to receive a feed stream containing PFAS-contaminated material, the vessel comprising a rotatable barrel having a receiving end, a discharging end, an interior surface, and an exterior surface. The systems may include a first heating region and a second heating region longitudinally-spaced along the length of the rotatable barrel, wherein the first heating region is adjacent the receiving end of the rotatable barrel and the second heating region is adjacent the first heating region. The first heating region may include a first section of induction heaters at least partially circumscribing the rotatable barrel and the second heating region may include a second section of induction heaters at least partially circumscribing the rotatable barrel. The systems may include a first barrel support system located longitudinally between the first heating region and the second heating region. The first barrel support system may be configured to support the rotatable barrel during operation. The first barrel support system may be operably connected to the exterior surface of the rotatable barrel. The systems may include an insulation sleeve concentrically surrounding the exterior surface of the rotatable barrel. The insulation sleeve may longitudinally extend as a unitary structure from proximal the receiving end to proximal the discharging end. The insulation sleeve separates the rotatable barrel from the first and second sections of induction heaters. The insulation sleeve may be located radially between the rotatable barrel and the first and second sections of induction heaters (e.g., the insulation may partially encapsulate the induction heaters or be separate from the induction heaters). The insulation sleeve includes a first cutout where the first barrel support system is operably connected to the exterior surface of the rotatable barrel. The insulation sleeve is configured to be stationary relative to the rotatable barrel during operation.

The systems may include a third heating region longitudinally-spaced along the length of the rotatable barrel. The third heating region may include a third section of induction heaters at least partially circumscribing the rotatable barrel. The systems may include a second barrel support system located longitudinally between the second heating region and the third heating region, wherein the second barrel support system is configured to support the rotatable barrel during operation and is operably connected to the exterior surface of the rotatable barrel. The insulation sleeve may include a second cutout where the second barrel support system is operably connected to the exterior surface of the rotatable barrel.

The systems may include a third barrel support system located longitudinally between the first heating region and the receiving end of the rotatable barrel. The third barrel support system may be configured to support the rotatable barrel during operation and may be operably connected to the exterior surface of the rotatable barrel. The insulation sleeve may include a third cutout where the third barrel support system is operably connected to the exterior surface of the rotatable barrel.

The systems may include a fourth barrel support system located longitudinally between the second heating region and the discharging end of the rotatable barrel. The fourth barrel support system may be configured to support the rotatable barrel during operation and may be operably connected to the exterior surface of the rotatable barrel. The insulation sleeve may include a fourth cutout where the fourth barrel support system is operably connected to the exterior surface of the rotatable barrel.

The insulation sleeve may be separated from the exterior surface of the rotatable barrel by an air gap, such as, for example, from ¼ inch to 3 inch.

In certain embodiments, the first barrel support system and the portion of the rotatable barrel operably connected to the first barrel support system may not be inductively heated by the first or second heating regions. In those embodiments, the exterior surface of the portion of the rotatable barrel operably connected to the first barrel support system may be conductively and convectively heated by the inductively heated portions of the rotatable barrel. The first barrel support system may include a rotary wheel in contact with the exterior surface of the rotatable barrel.

The first section of inductive heaters and the second section of inductive heaters may each comprise multiple inductive coils. Each section of inductive heaters may also be a separate set of inductive heaters.

The rotatable barrel may be configured for horizontal operation.

The systems may include a feed hopper operatively coupled to the receiving end of the rotatable barrel.

The rotatable barrel may be at least twenty feet long. The entire system may be designed to fit within a standard forty-foot shipping container.

The systems may include a first set of temperature sensors in the first heating region and a second set of temperature sensors in the second heating region. The temperature sensors may be non-contact temperature sensors that penetrate the insulation sleeve and are configured to measure the temperature of the exterior surface of the rotatable barrel without contacting the rotatable barrel.

The systems may include a feed auger operably connected to the receiving end of the rotatable barrel and a discharge auger operably connected to the discharging end of the rotatable barrel. During operation and when filled with material, the feed auger and the discharge auger may be operably connected sufficient to limit ingress of atmospheric air into the interior of the rotatable barrel. A fan may be operably connected to the feed auger and configured to generate negative pressure in the feed auger and in the interior of the rotatable barrel. The fan may be configured to generate a pressure in the interior of the rotatable barrel of 0 to −5 inches of water column.

The systems may include a pollution control package, such as a high-temperature thermal oxidizer (also referred to herein as an afterburner), operably coupled to the vessel and configured to increase the temperature of gases and vapors exiting the rotatable barrel. The system components may be containerized for mobile operation and configured and sized for transport by tractor-trailer, train, barge, or aircraft.

A mobile power transformer may be configured to operably connect power sources (e.g., medium voltage power sources) to the heating regions.

The systems may be configured to heat the material in the vessel to at least 1200° F., 1300° F., 1400° F., 1500° F., 1600° F., 1700° F., or 1800° F. or to heat the vessel to 1200° F. to 2400° F., 1200° F. to 2200° F., 1200° F. to 2000° F., or 1200° F. to less than 2000° F.

Systems are also disclosed herein for preventing thermal shock in a heated rotary vessel.

The systems may include a first set of temperature sensors (e.g., the non-contact temperature sensors discussed above) in a first heating region of a rotatable barrel of a rotary vessel. The systems may include a first section of heaters in the first heating region (e.g., the first section of induction heaters discussed above). The first heating region may be divided into a first plurality of temperature zones, wherein each of the first plurality of temperature zones includes a temperature sensor from the first set of temperature sensors and at least one heater from the first section of heaters. Each of the first plurality of temperature zones may be longitudinally adjacent to each other.

The first heating region may be an arcuate region partially circumscribing the rotatable barrel. Each of the first plurality of temperature zones may likewise be an arcuate region partially circumscribing the rotatable barrel.

The first heating region may be a cylindrical region circumscribing the rotatable barrel. Each of the first plurality of temperature zones may likewise be a cylindrical region circumscribing the rotatable barrel.

The systems may include a second set of temperature sensors (e.g., the non-contact temperature sensors discussed above) in a second heating region of the rotatable barrel of the rotary vessel, the second heating region being longitudinally adjacent the first heating region. The systems may include a second section of heaters (e.g., the second section of induction heaters discussed above) in the second heating region. The second heating region may be divided into a second plurality of temperature zones, wherein each of the second plurality of temperature zones includes a temperature sensor from the second set of temperature sensors and at least one heater from the second section of heaters. Each of the second plurality of temperature zones may be longitudinally adjacent to each other.

The second heating region may be an arcuate region partially circumscribing the rotatable barrel. Each of the second plurality of temperature zones may likewise be an arcuate region partially circumscribing the rotatable barrel.

The second heating region may be a cylindrical region circumscribing the rotatable barrel. Each of the second plurality of temperature zones may likewise be a cylindrical region circumscribing the rotatable barrel.

The systems may include a processor and a memory communicatively coupled to the processor and storing instructions that, when executed by the processor, perform operations, including: monitoring temperature readings from the first set of temperature sensors in the first heating region, monitor temperature readings from the second set of temperature sensors in the second heating region, and modulate the first section of heaters and the second section of heaters to maintain an even temperature profile longitudinally along the rotatable barrel.

The systems may include instructions to compare a temperature in each of the first plurality of temperature zones to a first heating region set point and reduce a power output in all of the first section of heaters when the temperature in one or more of the first plurality of temperature zones exceeds the first heating region set point.

The systems may include instructions to compare a temperature in each of the second plurality of temperature zones to a second heating region set point and reduce a power output in all of the second section of heaters when the temperature in one or more of the second plurality of temperature zones exceeds the second region set point.

The systems may include a first edge temperature sensor proximal a first temperature zone of the first plurality of temperature zones. The memory may further include instructions for comparing a temperature of the first edge temperature sensor to a temperature of the first temperature zone of the first plurality of temperature zones to determine a first temperature difference, comparing the first temperature difference to a first set maximum differential value, and based on the first temperature difference exceeding the first set maximum differential value, reducing the power output in the at least one heater of the first temperature zone of the first plurality of cylindrical temperature zones.

The systems may include a second edge temperature sensor proximal a last temperature zone of the first plurality of temperature zones. The memory may further include instructions for comparing a temperature of the second edge temperature sensor to a temperature of the last temperature zone of the first plurality of temperature zones to determine a second temperature difference, comparing the second temperature difference to a second set maximum differential value, and based on the second temperature difference exceeding the second set maximum differential value, reducing the power output in the at least one heater of the last temperature zone of the first plurality of temperature zones.

The systems may include a third edge temperature sensor proximal a first temperature zone of the second plurality of temperature zones. The memory may further include instructions for comparing a temperature of the third edge temperature sensor to a temperature of the first temperature zone of the second plurality of temperature zones to determine a third temperature difference, comparing the third temperature difference to a third set maximum differential value, and based on the third temperature difference exceeding the third set maximum differential value, reducing the power output in the at least one heater of the first temperature zone of the second plurality of temperature zones.

The systems may include a fourth edge temperature sensor proximal a last temperature zone of the second plurality of temperature zones. The memory may further include instructions for comparing a temperature of the fourth edge temperature sensor to a temperature of the last temperature zone of the second plurality of temperature zones to determine a fourth temperature difference, comparing the fourth temperature difference to a fourth set maximum differential value, and based on the fourth temperature difference exceeding the fourth set maximum differential value, reducing the power output in the at least one heater of the last temperature zone of the second plurality of temperature zones.

The systems may include a first intermediate temperature sensor in a first unheated region of the rotatable barrel of the rotary vessel, the first unheated region located longitudinally between the first heating region and the second heating region. The memory may further include instructions for comparing a temperature of the first intermediate temperature sensor to a temperature of the last temperature zone of the first plurality of temperature zones to determine a fifth temperature difference, comparing the fifth temperature difference to a fifth set maximum differential value, and based on the fifth temperature difference exceeding the fifth set maximum differential value, reducing the power output in the at least one heater of the last temperature zone of the first plurality of temperature zones. The memory may further include instructions for comparing a temperature of the first intermediate temperature sensor to a temperature of the first temperature zone of the second plurality of temperature zones to determine a sixth temperature difference, comparing the sixth temperature difference to a sixth set maximum differential value, and based on the sixth temperature difference exceeding the sixth set maximum differential value, reducing the power output in the at least one heater of the first temperature zone of the second plurality of temperature zones.

The systems may include a third set of temperature sensors in a third heating region of the rotatable barrel of the rotary vessel, the third heating region located longitudinally adjacent to the second heating region. The third heating region may be divided into a third plurality of temperature zones, wherein each of the third plurality of temperature zones includes a temperature sensor from the third set of temperature sensors and at least one heater from the third section of heaters. The systems may include a third section of heaters in the third heating region. Each of the third plurality of temperature zones may be longitudinally adjacent to each other.

The third heating region may be an arcuate region partially circumscribing the rotatable barrel. Each of the third plurality of temperature zones may likewise be an arcuate region partially circumscribing the rotatable barrel.

The third heating region may be a cylindrical region circumscribing the rotatable barrel. Each of the third plurality of temperature zones may likewise be a cylindrical region circumscribing the rotatable barrel.

The memory may further include instructions for monitoring temperature readings from the third set of temperature sensors in the third heating region and modulating the third section of heaters to maintain an even temperature profile longitudinally along the rotatable barrel. The system may include instructions for comparing a temperature in each of the third plurality of temperature zones to a third heating region set point and reducing a power output in all of the third section of heaters when the temperature in one or more of the third plurality of temperature zones exceeds the third heating region set point.

The systems may include a fifth edge temperature sensor proximal a first temperature zone of the third plurality of temperature zones. The memory may further include instructions for comparing a temperature of the fifth edge temperature sensor to a temperature of the first temperature zone of the third plurality of temperature zones to determine a seventh temperature difference, comparing the seventh temperature difference to a seventh set maximum differential value, and based on the seventh temperature difference exceeding the seventh set maximum differential value, reducing the power output in the at least one heater of the first temperature zone of the third plurality of temperature zones.

The systems may include a sixth edge temperature sensor proximal a last temperature zone of the third plurality of temperature zones. The memory may further include instructions for comparing a temperature of the sixth edge temperature sensor to a temperature of the last temperature zone of the third plurality of temperature zones to determine an eighth temperature difference, comparing the eighth temperature difference to a eighth set maximum differential value, and based on the eighth temperature difference exceeding the eighth set maximum differential value, reducing the power output in the at least one heater of the last temperature zone of the third plurality of temperature zones.

The systems may include a second intermediate temperature sensor in a second unheated region the rotatable barrel of the rotary vessel, the second unheated region located longitudinally between the second heating region and the third heating region. The memory may further include instructions for comparing a temperature of the second intermediate temperature sensor to a temperature of the last temperature zone of the second plurality of temperature zones to determine a ninth temperature difference, comparing the ninth temperature difference to a ninth set maximum differential value, and based on the ninth temperature difference exceeding the ninth set maximum differential value, reducing the power output in the at least one heater of the last temperature zone of the second plurality of temperature zone. The memory may further include instructions for comparing a temperature of the second intermediate temperature sensor to a temperature of the first temperature zone of the third plurality of temperature zones to determine a tenth temperature difference, comparing the tenth temperature difference to a tenth set maximum differential value, and based on the tenth temperature difference exceeding the tenth set maximum differential value, reducing the power output in the at least one heater of the first temperature zone of the third plurality of temperature zones.

Each of the set maximum differential values (e.g., the first set maximum differential value, the second set maximum differential value, the third set maximum differential value, the fourth set maximum differential value, the fifth set maximum differential value, the sixth set maximum differential value, the seventh set maximum differential value, the eighth set maximum differential value, the ninth set maximum differential value, and the tenth set maximum differential value) may be determined from finite element analysis of the rotatable barrel at different temperatures. For example, material-stress curves as a function of temperature can be modeled and the maximum safe temperature differentials determined between the various temperature sensor locations at different temperatures.

In addition to the particular maximum differential values specifically disclosed herein, other sensor combinations are possible, such as edge sensor to edge sensor maximum temperature differentials, maximum differentials between any two adjacent zones, maximum differentials between every other zone, etc. The temperature sensors may be uniformly spaced longitudinally along the barrel or be spaced non-uniformly longitudinally along the barrel.

The systems may include the first barrel support system (discussed above) located in the first unheated region and the second barrel support system (discussed above) in the second unheated region.

The systems may include the insulation sleeve (discussed above) with the first cutout where the first barrel support system is operably connected to the exterior surface of the rotatable barrel and with the second cutout where the second barrel support system is operably connected to the exterior surface of the rotatable barrel.

The systems may include the feed auger and discharge auger discussed above.

The systems may include the fan and pressure regime discussed above.

Likewise, the systems may include the afterburner discussed above.

The systems may be containerized for mobile operation and may be configured and sized for transport by tractor-trailer, train, barge, or aircraft. The systems may include a mobile power transformer configured to operably connect medium voltage power sources to inductive heaters. The systems may include further instructions for heating material in the vessel to at least 1200° F., 1300° F., 1400° F., 1500° F., 1600° F., 1700° F., or 1800° F. or heating the vessel to 1200° F. to 2400° F., 1200° F. to 2200° F., 1200° F. to 2000° F., or 1200° F. to less than 2000° F.

The systems, subsystems, components, and processes disclosed herein can be combined into a single system, such as in the embodiment disclosed in the figures. Alternatively, portions of the systems, subsystems, components, and processes disclosed herein can be selectively combined together.

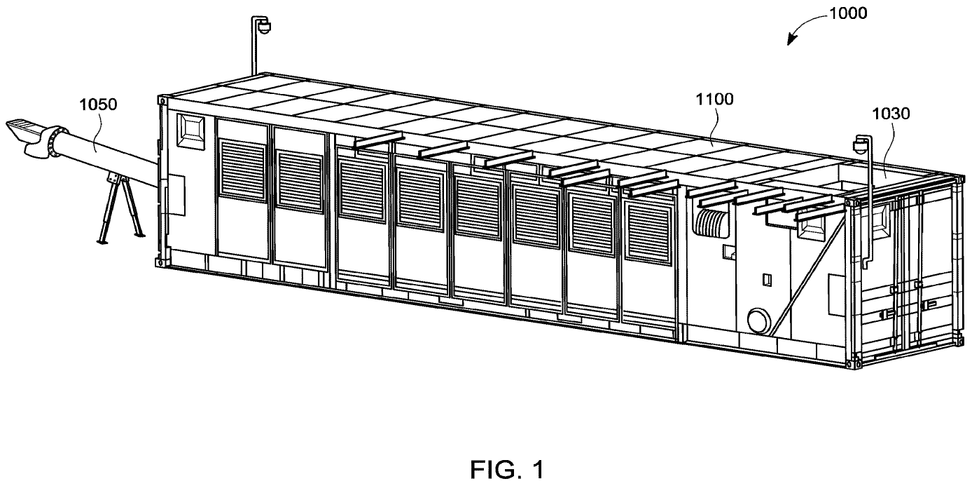

FIGS. 1-3 illustrate one embodiment of the systems disclosed herein, system 1000. System 1000 is for removing per-and polyfluoroalkyl substance (PFAS) compounds. System 1000 is containerized in a standard 40-foot shipping container (i.e., not a so-called “high-cube”) 1100. The shipping container 1100 has been modified for integration with the system 1000; however, the overall footprint is unchanged. FIG. 1 illustrates a perspective view of the shipping container 1100 stationary on the ground, after it has been unloaded from the flat bed of a tractor-trailer.

The opening of the feed hopper 1030 is in the roof of the shipping container 1100 in the illustrated embodiment; however, in other embodiments, the feed hopper 1030 may be in other locations. FIG. 1 depicts the discharge auger 1050 in place. At least a portion of the discharge auger 1050 is assembled after the shipping container 1100 is in position at the remediation site.

Other containerized system components, including a mobile power transformer, operator control station, and afterburner are not illustrated, but would be placed near the shipping container 1100 and operably connected thereto.

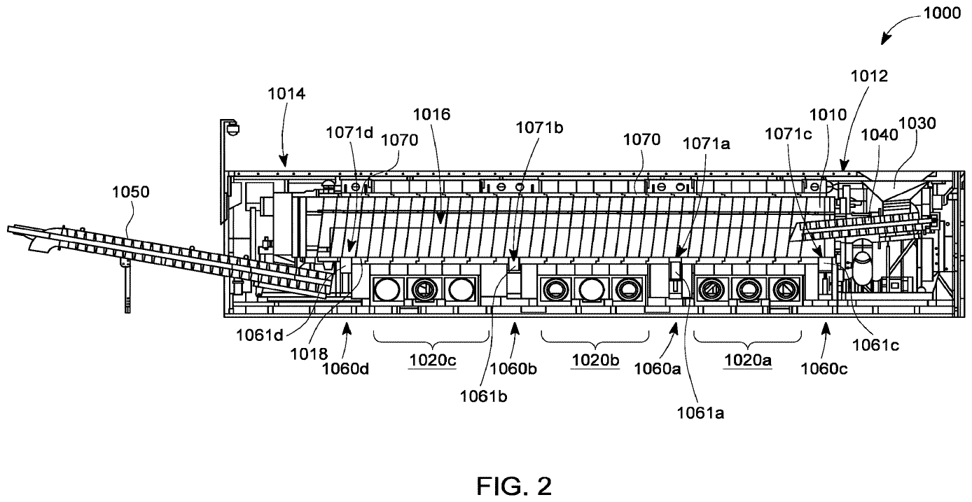

FIG. 2 illustrates a cross-sectional side view of the system 1000. The feed hopper 1030 feeds material to a receiving auger 1040. The receiving auger 1040 then feeds material to the rotatable barrel 1010. In the illustrated embodiment, the rotatable barrel 1010 is configured for horizontal operation (relative to the ground the shipping container 1100 sits on). In other embodiments, the rotatable barrel 1010 may be at an angle. A discharge auger 1050 is operably connected to the discharging end 1014 of the rotatable barrel 1010. During operation and when filled with material, the feed auger 1040 and the discharge auger 1050 limit the ingress of atmospheric air into the interior of the rotatable barrel 1010. A fan (not shown) is connected to a thermal oxidizer (not shown), which is connected via ductwork to the feed auger 1040. The fan draws gases and vapors from the interior of the rotatable barrel 1010 and may generate a negative pressure within both the feed auger 1040 and the rotatable barrel 1010. During steady-state operation, the pressure inside the rotatable barrel 1010 is preferably 0 to −5 inches of water column. In the illustrated embodiment, the thermal oxidizer destroys any PFAS compounds present in the materials (e.g., gases and vapors) pulled by the fan from the feed auger 1040.

In other embodiments, the fan may connect with the system 1000 at a point other than the feed auger 1040 and may be configured to generate different pressures within the rotatable barrel 1010. Additionally, in other embodiments the thermal oxidizer may not be present.

System 1000 includes a vessel configured to receive a feed stream containing PFAS-contaminated material. The vessel includes a rotatable barrel 1010 having a receiving end 1012, a discharging end 1014, an interior surface 1016, and an exterior surface 1018. The system 1000 includes a first heating region 1020a, a second heating region 1020b, and a third heating region 1020c, each longitudinally-spaced along the length of the rotatable barrel 1010. The first heating region 1020a is adjacent the receiving end 1012, the second heating region 1020b is adjacent the first heating region 1020a and the third heating region 1020c (i.e., between the first and third heating regions 1020a and 1020c), and the third heating region 1020c is adjacent the discharging end 1014.

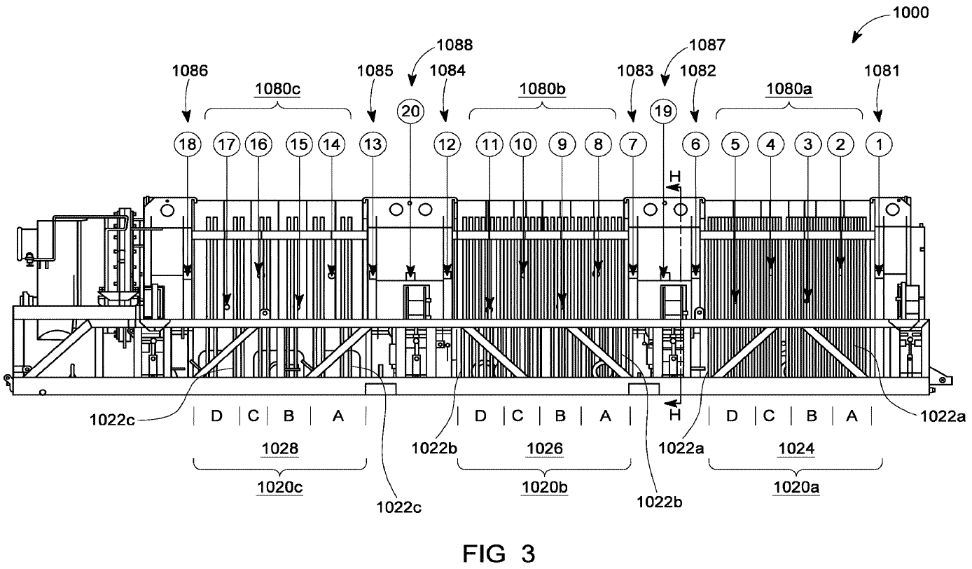

The first heating region 1020a includes a first set of induction heaters 1022a (see FIG. 3) circumscribing the rotatable barrel 1010. The second heating region 1020b includes a second set of induction heaters 1022b (see FIG. 3) circumscribing the rotatable barrel 1010. The third heating region 1020c includes a third set of induction heaters 1022c (see FIG. 3) circumscribing the rotatable barrel 1010 The system 1000 includes a first barrel support system 1060a located longitudinally between the first heating region 1020a and the second heating region 1020b. The system 1000 includes a second barrel support system 1060b located longitudinally between the second heating region 1020b and the third heating region 1020c. The system 1000 includes a third barrel support system 1060c located longitudinally between the first heating region 1020a and the receiving end 1012 of the rotatable barrel 1010. The system 1000 includes a fourth barrel support system 160d located longitudinally between the second heating region 1020b and the discharging end 1014 of the rotatable barrel 1010 (in particular, between the third heating region 1020c and the discharging end 1014 of the rotatable barrel 1010). The first, second, third, and fourth barrel support systems 1060a, 1060b, 1060c, and 1060d are each configured to support the rotatable barrel 1010 during operation and are each operably connected to the exterior surface 1018 of the rotatable barrel 1010.

The first barrel support system 1060a includes a rotary wheel 1061a in contact with the exterior surface 1018 of the rotatable barrel 1010. The second barrel support system 1060b includes a rotary wheel 1061b in contact with the exterior surface 1018 of the rotatable barrel 1010. The third barrel support system 1060c includes a rotary wheel 1061c in contact with the exterior surface 1018 of the rotatable barrel 1010. The first barrel support system 1060d includes a rotary wheel 1061d in contact with the exterior surface 1018 of the rotatable barrel 1010.

The system 1000 includes an insulation sleeve 1070 concentrically surrounding the exterior surface 1018 of the rotatable barrel 1010. The insulation sleeve 1070 longitudinally extends from proximal the receiving end 1012 to proximal the discharging end 1014. The insulation sleeve separates the rotatable barrel 1010 from the first, second, and third sets of induction heaters 1022a, 1022b, and 1022c. The insulation sleeve 1070 includes a first cutout 1071a where the first barrel support system 1060a is operably connected to the exterior surface 1018 of the rotatable barrel, e.g., where rotary wheel 1061a contacts the exterior surface 1018 of the rotatable barrel 1010. Likewise, the insulation sleeve 1070 includes a second cutout 1071b where the second barrel support system 1060b is operably connected to the exterior surface 1018 of the rotatable barrel, e.g., where rotary wheel 1061b contacts the exterior surface 1018 of the rotatable barrel 1010. The insulation sleeve 1070 includes a third cutout 1071c where the third barrel support system 1060c is operably connected to the exterior surface 1018 of the rotatable barrel, e.g., where rotary wheel 1061c contacts the exterior surface 1018 of the rotatable barrel 1010. The insulation sleeve 1070 includes a fourth cutout 1071d where the fourth barrel support system 1060d is operably connected to the exterior surface 1018 of the rotatable barrel, e.g., where rotary wheel 1061d contacts the exterior surface 1018 of the rotatable barrel 1010.

The insulation sleeve 1070 is configured to be stationary relative to the rotatable barrel 1010 during operation. An air gap of about ¼ inch separates the insulation sleeve 1070 from the exterior surface 1018 of the rotatable barrel 1010. In other embodiments, the air gap may be more or less. For example, in some embodiments the air gap may be any distance between ¼ inch to 3 inch. The insulation sleeve 1070 in the illustrated embodiment is made of a quasi-ceramic material; however, other insulation materials may be used.

The rotatable barrel 1010 in the illustrated embodiment is more than 20 feet long, which presents challenges for an inductively heated, rotating, cylindrical tube operating at high temperatures (1200° F. to 2400° F.). It is desirable to not overheat the first and second barrel support systems 1060a and 1060b. This can result in unheated regions of the rotatable barrel 1010. The unheated regions cause temperature differentials in the rotatable barrel 1010. The temperature differentials can cause fracturing due to thermal stress. The insulation sleeve 1070, which in the illustrated embodiment is stationary, unitary, and cylindrical, minimizes temperature differentials between heated and unheated regions of the rotatable barrel 1010, such as by limiting convective and radiative cooling of the unheated regions. In this way, heated sections at the desired temperature conductively transfer heat to the unheated regions, causing their temperature to be closer to the heated region. The system 1000 also includes a control system for preventing fracture of the rotatable barrel 1010 due to thermal stress. The processes and systems disclosed herein may also be beneficial for rotatable barrels less than 20 feet in length, such as 10 or 15 feet in length.

Referring to FIG. 3, the system 1000 is also configured for preventing thermal shock in the rotatable barrel 1010. FIG. 3 illustrates a sideview of the system 1000 without the feed hopper 1030, receiving auger 1040, the discharge auger 1050, and the shipping container 1100, among other components. As illustrated in FIG. 3, the system 1000 includes a first set of temperature sensors 1080a (labeled 2, 3, 4, and 5 in FIG. 3) in the first heating region 1020a. A second set of temperature sensors 1080b (labeled 8, 9, 10, and 11 in FIG. 3) in the second heating region 1020b and a third set of temperature sensors 1080c (labeled 14, 15, 16, and 17 in FIG. 3) in the third heating region 1020c.

For control purposes in the system 1000, each of the heating regions is divided into four cylindrical temperature zones, A-D. Each of the temperature zones corresponds to a temperature sensor and at least one heater. The temperature sensors may be non-contact temperature sensors that penetrate the insulation sleeve 1070 and are configured to measure the temperature of the exterior surface 1018 of the rotatable barrel 1010 without contacting the rotatable barrel 1010. The first heating region 1020a includes cylindrical temperature zones 1024A, 1024B, 1024C, and 1024D (corresponding respectively to the first set of temperature sensors 1080a, labeled 2, 3, 4, and 5 in FIG. 3). The second heating region 1020b includes cylindrical temperature zones 1026A, 1026B, 1026C, and 1026D (corresponding respectively to the second set of temperature sensors 1080b, labeled 8, 9, 10, and 11 in FIG. 3). The third heating region 1020c includes cylindrical temperature zones 1028A, 1028B, 1028C, and 1028D (corresponding to the third set of temperature sensors 1080c labeled 14, 15, 16, and 17 in FIG. 3).

In the illustrated embodiment, cylindrical temperature zones 1024A, 1024B, and 1024C each have five inductive heating coils 1022a and cylindrical temperature zone 1024D has six inductive heating coils 1022a. Cylindrical temperature zones 1026A and 1026C each have three inductive heating coils 1022b and cylindrical temperature zones 1026B and 1026D each have four inductive heating coils 1022b. Cylindrical temperature zones 1028A and 1028D each have one inductive heating coil 1022c and cylindrical temperature zones 1028B and 1028C each have two inductive heating coils 1022c. In different embodiments, temperature zones may have differing numbers of heating coils.

The system 1000 also includes a first edge temperature sensor 1081 (labeled 1 in FIG. 3) proximal the cylindrical temperature zone 1024A. The system 1000 also includes a second edge temperature sensor 1082 (labeled 6 in FIG. 3) proximal the cylindrical temperature zone 1024D. The system 1000 also includes a third edge temperature sensor 1083 (labeled 7 in FIG. 3) proximal the cylindrical temperature zone 1026A. The system 1000 also includes a fourth edge temperature sensor 1084 (labeled 12 in FIG. 3) proximal the cylindrical temperature zone 1026D. The system 1000 also includes a fifth edge temperature sensor 1085 (labeled 13 in FIG. 3) proximal the cylindrical temperature zone 1028A. The system 1000 also includes a sixth edge temperature sensor 1086 (labeled 18 in FIG. 3) proximal the cylindrical temperature zone 1028D.

The edge temperature sensors are in regions that are not inductively heated; however, the regions are conductively and convectively heated by the regions of the rotatable barrel 1010 that are inductively heated. The first edge temperature sensor 1081 is near the receiving end 1012 of the rotatable barrel 1010. The second edge temperature sensor 1082 and the third edge temperature sensor 1083 are located in a first unheated region 1090 between the first and second heating regions 1020a and 1020b. The fourth edge temperature sensor 1084 and the fifth edge temperature sensor 1085 are located in a second unheated region 1091 between the second and third heating regions 1020b and 1020c. The sixth edge temperature sensor 1086 is near the discharging end 1014 of the rotatable barrel 1010.

The system 1000 includes a first intermediate temperature sensor 1087 in the first unheated region 1029a and a second intermediate temperature sensor 1088 in the second unheated region 1029b.

The system 1000 includes at least one processor and at least one memory communicatively coupled to the at least one processor and storing instructions that, when executed by the at least one processor, perform operations, including monitoring temperature readings from the first set of temperature sensors 1080a in the first heating region 1020a, monitoring temperature readings from the second set of temperature sensors 1080b in the second heating region 1020b, and monitoring temperature readings from the third set of temperature sensors 1080c in the third heating region 1020c.

The system 1000 is able to modulate the first set of inductive heaters 1022a, the second set of inductive heaters 1022b, and the third set of inducive heaters 1022c to maintain an even temperature profile longitudinally along the rotatable barrel 1010.

Advantageously, the system 1000 is able to prevent thermal shock damage to the rotatable barrel 1010 by reducing temperature differentials along the rotatable barrel 1010.

The system 1000 is able to compare a temperature in each of the cylindrical temperature zones 1024A, 1024B, 1024C, and 1024D to a first heating region set point and reduce a power output in some or all of the first set of 1022a inductive heaters when the temperature in one or more of the cylindrical temperature zones 1024A, 1024B, 1024C, and 1024D exceeds the first heating region set point.

Likewise, the system 1000 is able to compare a temperature in each of the cylindrical temperature zones 1026A, 1026B, 1026C, and 1026D to a second heating region set point and reduce a power output in some or all of the second set of 1022b inductive heaters when the temperature in one or more of the cylindrical temperature zones 1026A, 1026B, 1026C, and 1026D exceeds the second heating region set point.

Furthermore, the system 1000 is able to compare a temperature in each of the cylindrical temperature zones 1028A, 1028B, 1028C, and 1028D to a third heating region set point and reduce a power output in some or all of the third set of 1022c inductive heaters when the temperature in one or more of the cylindrical temperature zones 1028A, 1028B, 1028C, and 1028D exceeds the third heating region set point.

The system 1000 may include instructions for comparing a temperature of the first edge temperature sensor 1081 to a temperature of the cylindrical temperature zone 1024A to determine a first temperature difference, comparing the first temperature difference to a first set maximum differential value, and based on the first temperature difference exceeding the first set maximum differential value, reducing the power output in the inductive heater coils 1022a of the cylindrical temperature zone 1024A.

The system 1000 may include instructions for comparing a temperature of the second edge temperature sensor 1082 to a temperature of the cylindrical temperature zone 1024D to determine a second temperature difference, comparing the second temperature difference to a second set maximum differential value, and based on the second temperature difference exceeding the second set maximum differential value, reducing the power output in the inductive heater coils 1022a of the cylindrical temperature zone 1024D.

The system 1000 may include instructions for comparing a temperature of the third edge temperature sensor 1083 to a temperature of the cylindrical temperature zone 1026A to determine a third temperature difference, comparing the third temperature difference to a third set maximum differential value, and based on the third temperature difference exceeding the third set maximum differential value, reducing the power output in the inductive heater coils 1022b of the cylindrical temperature zone 1026A.

The system 1000 may include instructions for comparing a temperature of the fourth edge temperature sensor 1084 to a temperature of the cylindrical temperature zone 1026D to determine a fourth temperature difference, comparing the fourth temperature difference to a fourth set maximum differential value, and based on the fourth temperature difference exceeding the fourth set maximum differential value, reducing the power output in the inductive heater coils 1022b of the cylindrical temperature zone 1026D.

The system 1000 may include instructions for comparing a temperature of the fifth edge temperature sensor 1085 to a temperature of the cylindrical temperature zone 1028A to determine a seventh temperature difference, comparing the seventh temperature difference to a seventh set maximum differential value, and based on the seventh temperature difference exceeding the seventh set maximum differential value, reducing the power output in the inductive heater coils 1022c of the cylindrical temperature zone 1028A.

The system 1000 may include instructions for comparing a temperature of the sixth edge temperature sensor 1086 to a temperature of the cylindrical temperature zone 1028D to determine an eighth temperature difference, comparing the eighth temperature difference to an eighth set maximum differential value, and based on the eighth temperature difference exceeding the eighth set maximum differential value, reducing the power output in the inductive heater coils 1022c of the cylindrical temperature zone 1028D.

The system 1000 may include instructions for comparing a temperature of the first intermediate temperature sensor 1087 to a temperature of the second edge temperature sensor 1082 to determine a fifth temperature difference, comparing the fifth temperature difference to a fifth set maximum differential value, and based on the fifth temperature difference exceeding the fifth set maximum differential value, reducing the power output in the inductive heater coils 1022a of the cylindrical temperature zone 1024D.

The system 1000 may include instructions for comparing a temperature of the first intermediate temperature sensor 1087 to a temperature of the third edge temperature sensor 1083 to determine a sixth temperature difference, comparing the sixth temperature difference to a sixth set maximum differential value, and based on the sixth temperature difference exceeding the sixth set maximum differential value, reducing the power output in the inductive heater coils 1022b of the cylindrical temperature zone 1026A.

The system 1000 may include instructions for comparing a temperature of the second intermediate temperature sensor 1088 to a temperature of the fourth edge sensor 1084 to determine a ninth temperature difference, comparing the ninth temperature difference to a ninth set maximum differential value, and based on the ninth temperature difference exceeding the ninth set maximum differential value, reducing the power output in the inductive heater coils 1022b of the cylindrical temperature zone 1026D.

The system 1000 may include instructions for comparing a temperature of the second intermediate temperature sensor 1088 to a temperature of the fifth edge temperature sensor 1085 to determine a tenth temperature difference, comparing the tenth temperature difference to a tenth set maximum differential value, and based on the tenth temperature difference exceeding the tenth set maximum differential value, reducing the power output in the inductive heater coils 1022c of the cylindrical temperature zone 1028A.

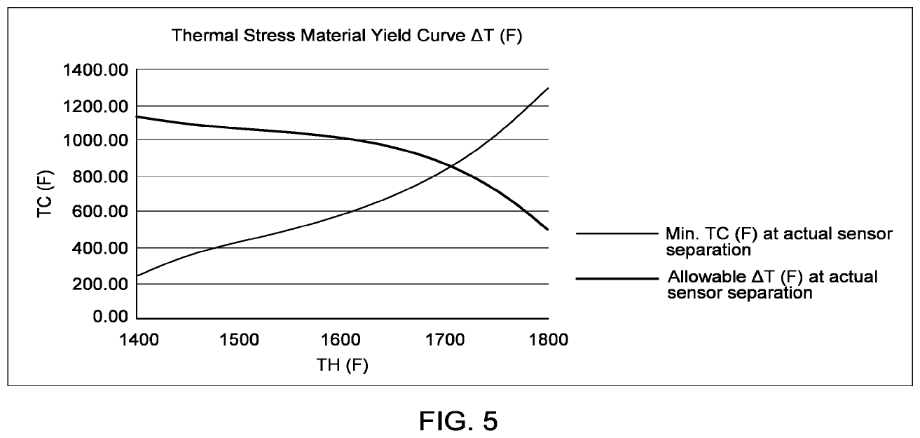

For the system 1000, each of the set maximum differential values was determined from finite element analysis of the rotatable barrel 1010 at different temperatures. The temperature sensors were evenly spaced and uniformly staggered along the longitudinal length of the rotatable barrel 1010. FIG. 5 illustrates an exemplary material-stress curve determined using finite element analysis for rotatable barrel 1010. This curve applies to any two adjacent temperature sensors. Tc is the temperature of the colder of the two temperature sensors. TH is the temperature of the hotter of the two temperature sensors. AT is the maximum temperature differential value between the two sensors. For this particular embodiment, AT tends to decrease with higher temperatures.

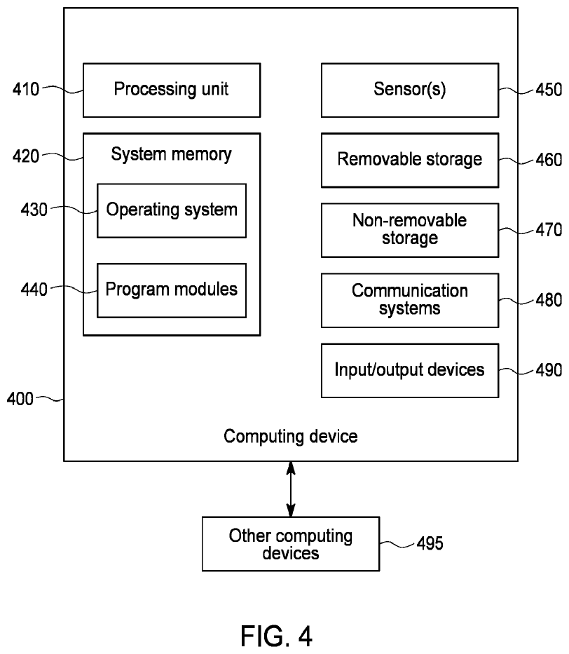

FIG. 4 is a system diagram of a computing device 400 according to an example. The computing device 400, or various components and systems of the computing device 400, may be integrated or otherwise associated with the system 1000 shown and described with respect to FIG. 1-FIG. 3. As shown in FIG. 4, the physical components (e.g., hardware) of the computing device 400 are illustrated and these physical components may be used to practice the various aspects of the present disclosure.

The computing device 400 may include at least one processing unit 410 and a system memory 420. The system memory 420 may include, but is not limited to, volatile storage (e.g., random access memory), non-volatile storage (e.g., read-only memory), flash memory, or any combination of such memories. The system memory 420 may also include an operating system 430 that controls the operation of the computing device 400, the system 1000 and/or one or more program modules 440 associated with the system 1000. The program modules 440 may be responsible for performing temperature readings, modulating heaters, comparing temperatures, controlling power outputs and the like. A number of different program modules and data files may be stored in the system memory 420. While executing on the processing unit 410, the program modules 440 may perform the various processes described above. The computing device 400 may also include a number of sensors 450. The sensors 450 may be temperatures sensors, image sensors, accelerometers and the like The computing device 400 may also have additional features or functionality. For example, the computing device 400 may include additional data storage devices (e.g., removable and/or non-removable storage devices) such as, for example, magnetic disks, optical disks, or tape. These additional storage devices are labeled as a removable storage 460 and a non-removable storage 470.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 400 on the single integrated circuit (chip). The disclosure may also be practiced using other technologies capable of performing logical operations such as, for example, AND, OR, and NOT, including but not limited to mechanical, optical, fluidic, and quantum technologies.

The computing device 400 may include one or more communication systems 480 that enable the computing device 400 to communicate with other computing devices 495 such as, for example, other systems, mobile computing devices, servers, client devices and the like. Example communication systems 480 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 400 may also have one or more input devices and/or one or more output devices shown as input/output devices 490. These input/output devices 490 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage 460, and the non-removable storage 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The benefits of the systems for preventing thermal shock described herein may be applicable to indirectly heated rotary systems generally, other than just inductively heated systems. For example, the systems and methods for preventing thermal shock disclosed herein may apply to gas-fired indirectly-heated rotary vessels. In addition, the systems described herein may be used to remove or treat contaminants other than PFAS.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art, and having the benefit of this disclosure, that changes may be made to the details of the above-described embodiments without departing from the underlying principles of the disclosure herein.

1. A system for removing per- and polyfluoroalkyl substance (PFAS) compounds, the system comprising:
a vessel configured to receive a feed stream containing PFAS-contaminated material, the vessel including a rotatable barrel having a receiving end, a discharging end, an interior surface, and an exterior surface;
a first heating region and a second heating region longitudinally-spaced along a length of the rotatable barrel of the vessel, wherein the first heating region is adjacent the receiving end of the rotatable barrel and the second heating region is adjacent the first heating region;
a first section of induction heaters at least partially circumscribing the rotatable barrel, the first section of induction heaters disposed within the first heating region;
a second section of induction heaters at least partially circumscribing the rotatable barrel, the second section of induction heaters disposed within the second heating region;
first barrel support system operably connected to the exterior surface of the rotatable barrel and located longitudinally between the first heating region and the second heating region, the first barrel support system supporting the rotatable barrel during operation; and
an insulation sleeve concentrically surrounding the exterior surface of the rotatable barrel, the insulation sleeve longitudinally extending from proximal the receiving end to proximal the discharging end, wherein the insulation sleeve separates the rotatable barrel from the first and second sections of induction heaters, wherein the insulation sleeve includes a first cutout where the first barrel support system is operably connected to the exterior surface of the rotatable barrel, and wherein the insulation sleeve is stationary relative to the rotatable barrel during operation.

2. The system of claim 1, further comprising:
a third heating region longitudinally-spaced along the length of the rotatable barrel, wherein the third heating region includes a third section of induction heaters at least partially circumscribing the rotatable barrel; and
a second barrel support system operably connected to the exterior surface of the rotatable barrel and located longitudinally between the second heating region and the third heating region, the second barrel support system supporting the rotatable barrel during operation, wherein the insulation sleeve includes a second cutout where the second barrel support system is operably connected to the exterior surface of the rotatable barrel.

3. The system of claim 2, further comprising a third barrel support system operably connected to the exterior surface of the rotatable barrel and located longitudinally between the first heating region and the receiving end of the rotatable barrel, the third barrel support system supporting the rotatable barrel during operation, wherein the insulation sleeve includes a third cutout where the third barrel support system is operably connected to the exterior surface of the rotatable barrel.

4. The system of claim 1, wherein the insulation sleeve is located radially between the rotatable barrel and the first and second sections of induction heaters.

5. The system of claim 3, further comprising a fourth barrel support system operably connected to the exterior surface of the rotatable barrel and located longitudinally between the second heating region and the discharging end of the rotatable barrel, wherein the fourth barrel support system is configured to support the rotatable barrel during operation, wherein the insulation sleeve includes a fourth cutout where the fourth barrel support system is operably connected to the exterior surface of the rotatable barrel.

6. The system of claim 1, wherein the insulation sleeve is separated from the exterior surface of the rotatable barrel by an air gap.

7. (canceled)

8. The system of claim 1, wherein the first barrel support system and the portion of the rotatable barrel operably connected to the first barrel support system are not inductively heated by the first or second heating regions, and wherein the exterior surface of the portion of the rotatable barrel operably connected to the first barrel support system is conductively and convectively heated by inductively heated portions of the rotatable barrel.

9. The system of claim 1, wherein the first section of inductive heaters and the second section of inductive heaters each comprises a plurality of inductive coils.

10. The system of claim 1, wherein the first barrel support system comprises a rotary wheel in contact with the exterior surface of the rotatable barrel.

11. The system of claim 1, wherein the rotatable barrel is configured for horizontal operation.

12. The system of claim 1, further comprising a feed hopper operatively coupled to a feed auger.

13. (canceled)

14. The system of claim 1, wherein the system fits within a standard forty-foot shipping container.

15. The system of any claim 1, further comprising one or more temperature sensors in the first heating region and one or more temperature sensors in the second heating region, wherein the one or more temperature sensors are non-contact temperature sensors that penetrate the insulation sleeve and are configured to measure the temperature of the exterior surface of the rotatable barrel without contacting the rotatable barrel.

16. The system of claim 1, further comprising:
a feed auger operably coupled to the receiving end of the rotatable barrel;
a discharge auger operably coupled to the discharging end of the rotatable barrel, wherein during operation and filled with material, the feed auger and the discharge auger are configured to and operably connected so as to limit ingress of atmospheric air into an interior of the rotatable barrel.

17. The system of claim 16, further comprising a fan operably connected to the feed auger and configured to generate negative pressure in the feed auger and in the interior of the rotatable barrel.

18. The system of claim 17, wherein the fan is configured to generate a pressure in the interior of the rotatable barrel of 0 to- 5 inches of water column.

19. The system of claim 1, further comprising a thermal oxidizer operably coupled to the vessel and configured to increase the temperature of exhaust exiting the rotatable barrel.

20. The system of claim 1, wherein the vessel, the first barrel support, and the insulation sleeve are containerized for mobile operation.

21. The system of claim 20, further comprising a mobile power transformer configured to operably connect one or more high voltage power sources to the heating regions.

22. The system of claim 1, wherein the system is configured to heat the material in the vessel to at least 1200° F., 1300° F., 1400° F., 1500° F., 1600° F., 1700° F., or 1800° F. or heating the vessel to 1200° F. to 2400° F., 1200° F. to 2200° F., 1200° F. to 2000° F., or 1200° F. to less than 2000° F.

23-53. (canceled)
